(19) United States
(12) Patent Application Publication
(10) Pub. No.: US 2026/0298635 A1
(43) Pub. Date: Oct. 1, 2026

(54) MICROELECTROMECHANICAL GYROSCOPE HAVING INTRINSIC SENSE SIGNAL DEMODULATION AND METHOD OF OPERATING SAID GYROSCOPE

(71) Applicant: STMicroelectronics International N.V., Geneva (CH)

(72) Inventors: Gabriele GATTERE, Castronno (Varese) (IT); Luca Giuseppe FALORNI, Desio (MB) (IT)

(73) Assignee: STMicroelectronics International N.V., Geneva (CH)

(21) Appl. No.: 19/566,401

(22) Filed: Mar. 13, 2026

(30) Foreign Application Priority Data
Mar. 27, 2025 (IT) 102025000006441

(51) Int. Cl. G01C 19/5712

(52) U.S. Cl. CPC G01C 19/5712

(57) ABSTRACT

A microelectromechanical gyroscope includes a support body, a drive mass constrained to the support body and able to oscillate along a drive direction, and a sense mass constrained to the drive mass to translate rigidly with the drive mass in the drive direction and able to oscillate with respect to the drive mass along a sense direction perpendicular to the drive direction. The gyroscope also includes a movable sensing electrode carried by the sense mass, and a fixed sensing electrode anchored to the support body and capacitively coupled to the movable sensing electrode. The movable sensing electrode and the fixed sensing electrode are shaped so that a capacitance between the movable sensing electrode and the fixed sensing electrode is a function of a position of the sense mass along the drive direction and of a position of the sense mass along the sense direction.

### PRIORITY CLAIM

This application claims the priority benefit of Italian Application for Patent No. 102025000006441 filed on Mar. 27, 2025, the content of which is hereby incorporated by reference in its entirety to the maximum extent allowable by law.

### TECHNICAL FIELD

The present invention relates to a microelectromechanical gyroscope, in particular to a mode-matched gyroscope, having an intrinsic sense-signal demodulation, and to a related method of operating such a gyroscope.

### BACKGROUND

As is known, microelectromechanical (MEMS) inertial sensors, such as, for example, MEMS gyroscopes, generally comprise a support body and at least one movable mass, suspended from and coupled to the support body through flexures. The flexures are configured to allow the movable mass to oscillate with respect to the support body according to one or more degrees of freedom. The movable mass is generally capacitively coupled to the support body and forms capacitors of variable capacitance with the support body. In particular, the movement of the movable mass with respect to fixed electrodes on the support body, due to the action of forces acting thereon, modifies the capacitance of these capacitors; the displacement of the movable mass with respect to the support body is sensed by this capacitive variation, and the external force that caused the displacement is calculated based on the sensed displacement.

Among MEMS inertial sensors, gyroscopes have a complex electromechanical structure that may comprise, for example, at least two movable masses, each having one or two degrees of freedom with respect to the support body, or a single movable mass provided with at least two degrees of freedom. In all cases, capacitive coupling occurs through fixed and movable actuation (or driving) electrodes and through fixed and movable sensing electrodes.

In one possible implementation, for example, two movable masses are coupled to the support body so as to be movable with respect to the support body with two independent degrees of freedom, and precisely one degree of freedom for actuation—along a drive direction—and one degree of freedom for sensing-along a sense direction. The degree of freedom for sensing may include, for example, movement along the plane of the movable masses (“in-plane” movement) or perpendicularly to the plane (“out-of-plane” movement). An actuation or drive device maintains the movable masses in controlled oscillation according to the degree of freedom for actuation, i.e., along the drive direction. The movable masses move in an oscillatory manner along the sense direction in response to rotation of the support body, due to the Coriolis force.

In some MEMS gyroscopes, the movable masses may oscillate along the drive direction and along the sense direction with respective frequencies that are different from each other; for example, the natural oscillation frequency with which the movable masses may oscillate along the sense direction may differ from the frequency at which the movable masses are maintained in oscillation along the drive direction. Such gyroscopes are referred to as “mode-split” gyroscopes. In other MEMS gyroscopes, instead, the oscillation frequency (i.e., the mechanical resonance frequency) along the sense direction is maintained substantially matched to the oscillation frequency along the drive direction, for example by a control loop implemented by a control device of the gyroscope. Such gyroscopes are referred to as “mode-matched” gyroscopes. This latter category of gyroscopes typically allows an increase in sense sensitivity, at the expense of a circuit solution required to maintain frequency matching between the sense direction and the drive direction, which may be complex.

In both mode-split gyroscopes and mode-matched gyroscopes, quadrature phenomena are often present as unwanted effects of manufacturing imperfections and give rise to spurious quadrature signals that add to the useful sense signal of the gyroscope and are phase-shifted with respect to the latter by 90°. Ideally, therefore, perfectly synchronous demodulation of the sense signal would allow extraction of only the information related to the angular velocity of the rotation to which the gyroscope is subjected. For example, in a mode-matched gyroscope, ideal coherent demodulation that uses the same drive signal as the demodulation signal would allow a useful signal reading free of contributions from quadrature phenomena.

However, in practice, phase errors in the signal used for demodulation—i.e., a phase shift between the sense signal and the demodulation signal-lead to the presence of a quadrature contribution in the gyroscope reading: this phenomenon is commonly known as “Zero Rate Level” (ZRL), as it generates an offset in the reading of the sense signal.

Phase errors in the demodulation of MEMS gyroscopes may originate from both signal-processing contributions and electromechanical contributions. For example, in mode-matched gyroscopes, each processing block used to demodulate the sense signal contributes in an uncorrelated manner to the phase shift between the sense signal and the demodulation signal. Even mode-split gyroscopes may not be free from phase errors in demodulation. In such gyroscopes, a phase shift between the sense signal and the demodulation signal may be caused by phase drifts due to thermomechanical stresses, such as excessive soldering temperatures, operating temperatures, humidity, and mechanical bending during mounting and soldering on printed circuit boards, as well as more generally by environmental disturbances. Such phase drifts may give rise to variable ZRL phenomena during the life of the gyroscope. Solutions that use phase compensation based on thermal sensing and typical phase-drift-versus-temperature matching maps may not be satisfactory, as they do not consider all the causes of stress and disturbances to which the gyroscope is subject.

A need is therefore felt to eliminate phase errors in the demodulation of the gyroscope sense signal, in order to reduce as much as possible reading contributions due to quadrature phenomena.

### SUMMARY

According to the present invention, a microelectromechanical gyroscope, in particular a “mode-matched” type gyroscope, and a method of operating said gyroscope are presented.

For example, a microelectromechanical gyroscope is provided that includes a support body, a drive mass constrained to the support body and able to oscillate along a drive direction, and a sense mass constrained to the drive mass to translate rigidly with the drive mass along the drive direction while oscillating with respect to the drive mass along a sense direction perpendicular to the drive direction. The gyroscope further includes a movable sensing electrode carried by the sense mass and at least one fixed sensing electrode anchored to the support body and capacitively coupled to the movable sensing electrode. The movable sensing electrode and the at least one fixed sensing electrode are shaped such that a capacitance between them is a function of a position of the sense mass along the drive direction and of a position of the sense mass along the sense direction.

In some embodiments, the capacitance between the movable sensing electrode and the at least one fixed sensing electrode may vary, in use, substantially with the same frequency and substantially in phase with an oscillation of the sense mass along the drive direction.

In some embodiments, the movable sensing electrode may have at least one sense surface that includes a first face, and the at least one fixed sensing electrode may have a respective sense surface arranged facing the at least one sense surface of the movable sensing electrode and including a second face. The first face and the second face may extend along the drive direction and be capacitively coupled to each other, and a projection of the first face on the second face along the sense direction may depend on the position of the sense mass along the drive direction.

In some embodiments, one of the at least one sense surface of the movable sensing electrode and the sense surface of the at least one fixed sensing electrode may have a step like profile, while the other may have a flat profile.

In some embodiments, the at least one sense surface of the movable sensing electrode may have a step like profile defined by the first face and a recessed face, with the first face being more proximal to the second face of the sense surface of the at least one fixed sensing electrode than the recessed face, while the sense surface of the at least one fixed sensing electrode may have a flat profile.

In some embodiments, the sense surface of the at least one fixed sensing electrode may have a step like profile defined by the second face and a recessed face, with the second face being more proximal to the first face of the at least one sense surface of the movable sensing electrode than the recessed face, while the at least one sense surface of the movable sensing electrode may have a flat profile.

In some embodiments, the movable sensing electrode may include a first arm extending along the drive direction and including the at least one sense surface, and the sense mass may further include a second arm extending along the sense direction, with the first arm and the second arm arranged as a cross with respect to one another.

In some embodiments, the first arm may include a first portion and a second portion, with the second arm interposed between the first portion and the second portion. Each of the first portion and the second portion may include a pair of sense surfaces of the movable sensing electrode opposite to each other along the sense direction. In such embodiments, a plurality of fixed sensing electrodes may be provided, with the sense surfaces of the first portion and of the second portion each arranged facing a respective sense surface of a corresponding fixed sensing electrode.

In some embodiments, the sense mass may further include a frame portion coupled to respective ends of the first arm and the second arm and defining respective sense openings together with the first arm and the second arm. Each sense opening may accommodate a respective fixed sensing electrode.

In some embodiments, the drive mass may have a frame shape and may define a drive opening, with the sense mass and the at least one fixed sensing electrode accommodated within the drive opening.

A method of operating a microelectromechanical gyroscope is also provided, in which the gyroscope includes a support body, a drive mass constrained to the support body and able to oscillate along a drive direction, a sense mass constrained to the drive mass to translate rigidly with the drive mass along the drive direction while oscillating with respect to the drive mass along a sense direction perpendicular to the drive direction, a movable sensing electrode carried by the sense mass, and at least one fixed sensing electrode anchored to the support body and capacitively coupled to the movable sensing electrode. The method includes causing the drive mass to oscillate along the drive direction and extracting a sense signal indicative of an oscillation of the sense mass along the sense direction, where the sense signal depends on a variation in capacitance between the movable sensing electrode and the at least one fixed sensing electrode.

In some embodiments of the method, the variation in capacitance between the movable sensing electrode and the at least one fixed sensing electrode may have substantially the same frequency as, and may be substantially in phase with, the oscillation of the sense mass along the drive direction.

In some embodiments of the method, extracting the sense signal may include modulating a bias voltage of the movable sensing electrode with a modulation signal, generating the sense signal using a charge to voltage converter, filtering the sense signal using a low pass filter with a cut off frequency equal to twice the oscillation frequency of the sense mass along the drive direction, and coherently demodulating the sense signal using the modulation signal.

A further method of operating a microelectromechanical gyroscope is provided that includes causing a drive mass of the gyroscope to oscillate along a drive direction, causing a sense mass of the gyroscope to translate with the drive mass along the drive direction while oscillating relative to the drive mass along a sense direction perpendicular to the drive direction, and extracting a sense signal indicative of the oscillation of the sense mass along the sense direction. The sense signal depends on a capacitance between a movable sensing electrode carried by the sense mass and at least one fixed sensing electrode anchored to a support body of the gyroscope, with the capacitance varying as a function of a position of the sense mass along the drive direction and as a function of a position of the sense mass along the sense direction.

In some embodiments of this method, the variation in capacitance between the movable sensing electrode and the at least one fixed sensing electrode may have substantially the same frequency as, and may be substantially in phase with, the oscillation of the sense mass along the drive direction.

In some embodiments of this method, extracting the sense signal may include modulating a bias voltage of the movable sensing electrode with a modulation signal, generating the sense signal using a charge to voltage converter, filtering the sense signal using a low pass filter with a cut off frequency equal to twice the oscillation frequency of the sense mass along the drive direction, and coherently demodulating the sense signal using the modulation signal.

### BRIEF DESCRIPTION OF THE DRAWINGS

For a better understanding of the present invention, preferred embodiments are presented, by way of non-limiting example, with reference to the attached drawings, wherein:

FIG. 1 shows a simplified block diagram of a MEMS gyroscope in accordance with an embodiment of the present invention;

FIG. 2 schematically shows, in a plan view, a MEMS structure of the MEMS gyroscope of FIG. 1 in accordance with an embodiment of the present invention;

FIG. 3 schematically shows an enlarged detail of the MEMS structure of FIG. 2;

FIGS. 4-6 schematically show respective embodiments of a detail of the MEMS structure of FIGS. 2 and 3; and

FIG. 7 shows a simplified block diagram relating to a portion of the MEMS gyroscope of FIG. 1.

### DETAILED DESCRIPTION

The following description refers to the arrangement shown in the drawings; consequently, expressions such as “above”, “below”, “upper”, “lower”, “top”, “bottom”, “right”, “left” and the like relate to the attached Figures and are not to be construed in a limiting manner.

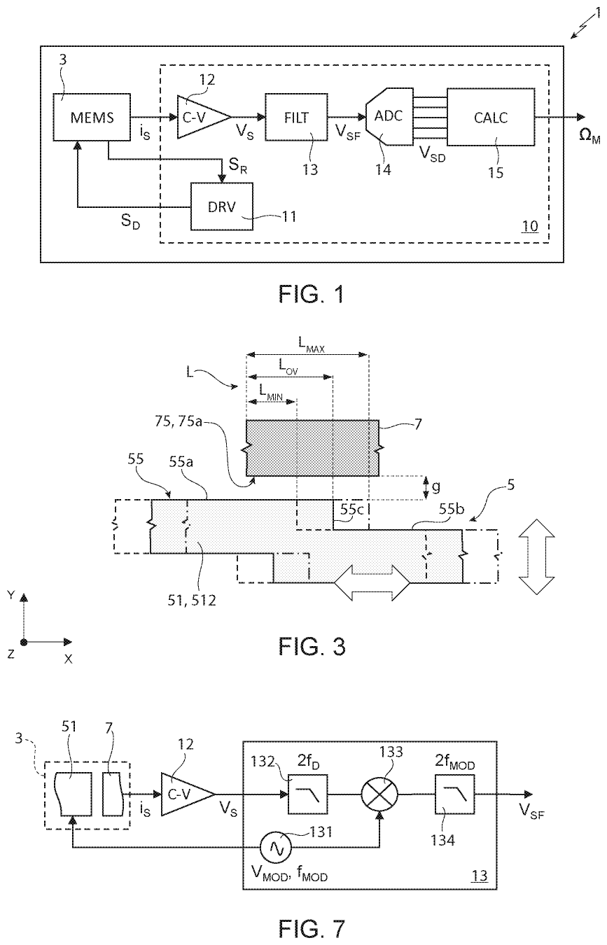

FIG. 1 shows a gyroscope according to one embodiment of the present invention, indicated as a whole by the reference numeral 1 and comprising a microelectromechanical (MEMS) structure 3 and an electronic processing unit 10. The gyroscope 1 is configured to sense a rotational movement about at least one axis and to generate at its output an angular velocity measurement Ω_{M}. In particular, the MEMS structure 3 produces a sense current is indicative of capacitive variations due to movements of internal components due to the Coriolis force; the electronic processing unit 10 is configured to receive at input and process the sense current iS in order to obtain the measurement Ω_{M}.

FIG. 2 shows a support body 2 of the gyroscope 1 and the MEMS structure 3 in accordance with an embodiment of the present invention. In detail, the MEMS structure 3 is constrained to the support body 2 of the gyroscope 1. The support body 2 is substantially planar and extends parallel to an XY plane defined by an X-axis and a Y-axis perpendicular to each other. Furthermore, the MEMS structure 3 is symmetrical with respect to a symmetry axis M parallel to the Y-axis. The support body 2 and the MEMS structure 3 are formed of semiconductor material; for example, they are both formed of silicon. The MEMS structure 3 comprises a set of drive masses and sense masses that are movable with respect to the support body 2 and are capacitively coupled to the same support body 2 by respective sets of fixed driving electrodes and fixed sensing electrodes.

In the embodiment of FIG. 2, in particular, the movable masses of the MEMS structure 3 are constrained to the support body 2 with relative degrees of freedom with respect to at least one direction of motion. Controlled movements of the movable drive masses with respect to the fixed driving electrodes, actuated for example capacitively, generate drive movements (or oscillations) of the MEMS structure 3, here for example along the X-axis (drive direction). Movements of the movable sense masses with respect to the fixed sensing electrodes—i.e., sense movements (or oscillations) of the MEMS structure 3, here for example along the Y-axis (sense direction)—generate capacitive variations indicative of rotational movements of the gyroscope 1 about a rotation axis, here for example a Z-axis perpendicular to the XY plane, due to the Coriolis force.

The MEMS structure 3 comprises, in detail, a pair of drive masses 4, a pair of movable sense masses 5, fixed driving electrodes 6, and fixed sensing electrodes 7, all anchored to the support body 2. In particular, the MEMS structure 3 is divided by the symmetry axis M into a first sector 31 and a second sector 32 that are specular to each other. Each of the first sector 31 and the second sector 32 contains a drive mass 4 and a movable sense mass 5, a respective set of fixed driving electrodes 6, and a respective set of fixed sensing electrodes 7.

The drive masses 4 are elastically constrained to the support body 2 so as to be able to oscillate along the X-axis (drive direction) and are provided with movable driving electrodes 45 capacitively coupled to respective fixed driving electrodes 6. The movable driving electrodes 45 and the fixed driving electrodes 6, for example of elongated shape along the X-axis and arranged in an interdigitated configuration, define a drive actuator operable to cause the drive masses 4 to move along the X-axis. Furthermore, at least one pair of movable driving electrodes 45 and fixed driving electrodes 6 for each sector act as so-called sensing drive electrodes, useful for extracting a feedback signal SR indicative of the velocity and position of each drive mass 4. In one embodiment, the drive actuator is controlled by the electronic processing unit 10 based on the feedback signal SR to maintain the drive masses 4 in oscillation along the X-axis in phase opposition.

In general, for clarity of understanding, in the attached figures fixed electrodes of the MEMS structure 3 are highlighted with a darker shade of gray than the corresponding movable electrodes or masses.

The movable sense masses 5 are constrained to the respective drive masses 4 so as to translate rigidly with the drive masses 4 along the X-axis and to be able to oscillate with respect to the drive masses 4 along the Y-axis (sense direction). According to what has been described above, therefore, without however this being considered limiting, the MEMS structure 3 is a structure in which the movable sense masses 5 are masses that are both affected by the Coriolis force (so-called “Coriolis masses”) and implement sensing of this force. Furthermore, again without limitation, in the embodiments shown the two independent degrees of freedom for actuation and sensing are both in-plane, and therefore the MEMS structure 3 is able to sense rotational movements of the gyroscope 1 about an out-of-plane direction, i.e., rotatory yaw movements. Finally, as described in more detail below, in one embodiment the MEMS structure 3 implements double-differential sensing.

Again with reference to FIG. 2, each drive mass 4 has a frame shape and delimits a through drive opening 41 in which the respective movable sense mass 5 and the respective set of fixed sensing electrodes 7 are accommodated. In detail, each movable sense mass 5 is elastically constrained to the respective drive mass 4 by sense elastic elements 42 that are compliant along the sense direction Y and substantially rigid with respect to the drive direction X. In a non-limiting embodiment, each movable sense mass 5 is arranged in a substantially central position within the respective drive opening 41 and is connected to the respective drive mass 4 by sense elastic elements 42 extending along the sense direction Y. The sense elastic elements 42 connect, for example, respective internal sides of the drive mass 4 to respective sides of the movable sense mass 5 facing each other along the sense direction Y.

Each drive mass 4 is elastically constrained to the support body 2 by anchors 43 and first drive elastic elements 44 that are compliant along the drive direction X. In the non-limiting embodiment of FIG. 2, for example, for each drive mass 4 a pair of anchors 43 is present, each anchor 43 being connected to the drive mass 4 by a respective first drive elastic element 44 extending along the drive direction X. Furthermore, the anchors 43 are arranged along the same external side of the respective drive mass 4, in proximity to ends of the drive mass 4 that are opposite to each other along the sense direction Y. Finally, the drive mass 4 of the first sector 31 of the MEMS structure 3 is connected to the drive mass 4 of the second sector 32 by second drive elastic elements 46 arranged centrally in the MEMS structure 3. The second drive elastic elements 46 are compliant along the drive direction X and constrain the movements of the drive masses 4 relative to each other, as further detailed below.

With reference again also to FIG. 1, in a particular embodiment the electronic processing unit 10—for example an application-specific integrated circuit (ASIC), comprises a drive module 11, which forms a drive loop configured to maintain the drive masses 4 in oscillation along the X-axis, a charge-to-voltage converter 12, a signal conditioning module 13, an analog-to-digital converter 14, and a digital unit 15. The drive module 11 is configured to generate a drive signal SD at a drive frequency, for example equal to 20 kHz, which is applied to the movable driving electrodes 45 of the drive masses 4. In more detail, the drive signal SD is applied to the movable driving electrodes 45 of the first sector 31 and to the movable driving electrodes 45 of the second sector 32 with inverted polarity. In this manner, a differential actuation of the MEMS structure 3 is obtained, as schematically represented by the arrows in FIG. 2. As anticipated, the sensing drive electrodes allow the feedback signal SR, which is used to maintain the drive loop in controlled oscillation—to be sent to the drive module 11, as schematically represented in FIG. 1.

The charge-to-voltage converter 12 reads a capacitive variation AC between movable sensing electrodes (described below) of the movable sense masses 5 and the respective fixed sensing electrodes 7 and provides a sense signal VS of the gyroscope 1. The sense signal VS is therefore indicative of movement of the movable sense masses 5 along the sense direction Y. For example, in a differential reading configuration, the charge-to-voltage converter 12 comprises a charge amplifier circuit for each movable sense mass-fixed sensing electrode pair.

The electronic processing unit 10 is configured to obtain angular velocity measurements Ω_{M} from the sense signal VS. In detail, the sense signal VS is first preliminarily processed by the signal conditioning module 13, which performs, as explained in more detail below, mainly filtering functions, thereby obtaining a filtered sense signal VSF. The filtered sense signal VSF is then converted into a digital sense signal VSD by the analog-to-digital converter 14. Finally, the digital sense signal VSD is processed by the digital unit 15, which comprises a calculation module of a known type, for example a digital signal processor (DSP), configured to provide the angular velocity measurements 52M. In a non-limiting embodiment, the digital unit 15 further comprises a digital compensator (or DCU), for tuning the sensitivity of the gyroscope 1, and additional digital filters, for example finite impulse response (FIR) or infinite impulse response (IIR) filters, for reducing output noise.

With reference now to FIG. 2 and FIG. 3, the movable sense masses 5 are provided with respective movable sensing electrodes capacitively coupled to respective fixed sensing electrodes 7. The movable sensing electrodes and the fixed sensing electrodes 7 are shaped such that the capacitance between the movable sensing electrodes and the fixed sensing electrodes 7 is a function of a position of the respective movable sense mass 5 along the drive direction X and of a position of the respective movable sense mass 5 along the sense direction Y.

In more detail, the movable sensing electrodes are defined by respective portions of the movable sense masses 5 facing the respective fixed sensing electrodes 7. Along the sense direction Y, the movable sensing electrodes are separated from the respective fixed sensing electrodes 7 by a distance at rest, indicated below as a sense gap g. Therefore, displacements of the movable sense masses 5 along the sense direction Y determine variations of the sense gap g and therefore corresponding capacitive variations AC of the capacitive coupling.

In the non-limiting embodiment of FIG. 2, each movable sense mass 5 is capacitively coupled to a plurality of fixed sensing electrodes 7, four per sector in FIG. 2, arranged to implement a differential reading of movement of the respective movable sense mass 5 along the sense direction Y. According to the foregoing description, the MEMS structure 3 is therefore said to be in a “double differential” configuration.

Considering for simplicity only one of the first sector 31 and the second sector 32 of the MEMS structure 3 (analogous considerations also apply to the other sector), the movable sense mass 5 comprises, in one embodiment, a first arm 51, a second arm 52, and a frame portion 53. The first arm 51 extends mainly along the drive direction X, and the second arm 52 extends mainly along the sense direction Y. The first arm 51 and the second arm 52 are arranged in a cross-like configuration. In particular, the second arm 52 divides the first arm 51 into a first portion 511 and a second portion 512 that are symmetrical to each other with respect to the second arm 52, such that the second arm 52 is interposed between the first portion 511 and the second portion 512. The frame portion 53 surrounds the first arm 51 and the second arm 52 and is coupled thereto at respective ends. The frame portion 53 therefore delimits, together with the first arm 51 and the second arm 52, four respective through sense openings 54. The frame portion 53 is connected to the sense elastic elements 42 on two external sides facing the drive mass 4.

Each sense opening 54 accommodates a respective fixed sensing electrode 7, anchored to the support body 2 and arranged substantially centrally within the sense opening 54. In a non-limiting embodiment, the fixed sensing electrodes 7 have a substantially rectangular shape in plan view. Each fixed sensing electrode 7 therefore has two respective sides facing the frame portion 53 of the movable sense mass 5, one respective side facing the first arm 51, alternatively facing the first portion 511 or the second portion 512, and one respective side facing the second arm 52. The first arm 51 of the movable sense mass 5 is capacitively coupled in a differential manner to the fixed sensing electrodes 7 and thus defines the movable sensing electrode. For the mutual facing between each fixed sensing electrode 7 and the movable sense mass 5, sense surfaces 75 of the fixed sensing electrodes 7 and respective sense surfaces 55 of the movable sense mass 5 (in particular of the first arm 51, alternatively of the first portion 511 or the second portion 512) facing each other are referred to below as “sense surfaces.” The movable sense mass 5, and in particular the first arm 51, therefore comprises, in the embodiment of FIG. 2, four sense surfaces 55 delimiting, on a respective side, the respective sense openings 54.

More specifically, each of the first portion 511 and the second portion 512 comprises a pair of sense surfaces 55 that are opposite to each other along the sense direction Y, each arranged facing a respective sense surface 75 of the corresponding fixed sensing electrode 7. In general, the sense surfaces 75 of each fixed sensing electrode 7 and the sense surfaces 55 of the movable sense mass 5 extend mainly along the drive direction X.

According to one aspect of the present invention, the mutually facing sense surfaces 55 and 75 are shaped to define between each other a first coupling portion, in which the mutually facing sense surfaces 55 and 75 are separated by a first distance, and a second coupling portion, in which the mutually facing sense surfaces 55 and 75 are separated by a second distance that is different from the first distance, for example greater than the first distance. The position of the movable drive mass 4 along the drive direction X determines, for each pair of mutually facing sense surfaces 55 and 75, a ratio between the areas of the first coupling portion and the second coupling portion and, consequently, the capacitance between the movable sense mass 5 and each of the fixed sensing electrodes 7. The second distance may also be such that, in the second coupling portion, the capacitive coupling is in fact negligible. In this case, the capacitance is substantially determined by the area of the first coupling portion.

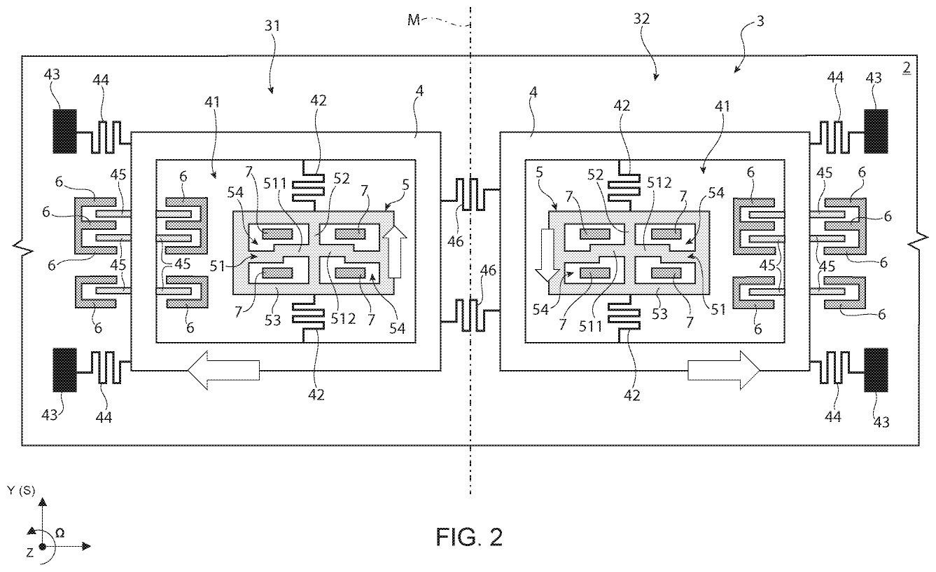

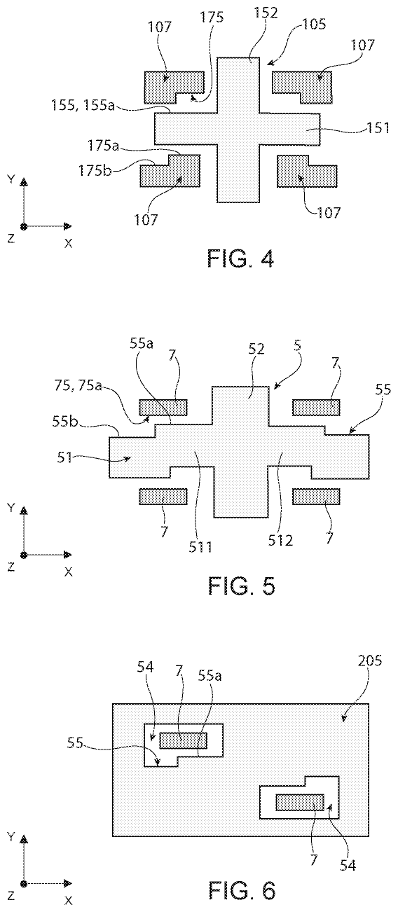

In detail, as also explained below and as also shown in the embodiments of FIGS. 4-6, one of at least one of the sense surface 55 of the movable sense mass 5 and the sense surface 75 of each fixed sensing electrode 7 is shaped, for example with a step-like profile, to define a variable facing in the sense capacitive coupling, while the other sense surface between the sense surfaces 55 and 75 has a substantially flat profile. In the embodiment of FIGS. 2 and 3, for example, the first arm 51 (i.e., both the first portion 511 and the second portion 512) of the movable sense mass 5 is shaped to define a variable facing between the movable sense mass 5 and each fixed sensing electrode 7 as a function of the position of the movable sense mass 5 along the drive direction X. The sense surfaces 75 of the fixed sensing electrodes 7 are instead substantially flat surfaces. Furthermore, again in a non-limiting manner, an overall length of each fixed sensing electrode 7 along the drive direction X is less than the corresponding length of the respective first portion 511 or second portion 512 of the first arm 51.

In general, each sense surface 55 of the movable sense mass 5 and the sense surface 75 of each fixed sensing electrode 7 respectively comprise a first face 55a and a second face 75a that extend along the drive direction X and are capacitively coupled to each other. In the MEMS structure 3 of the gyroscope 1 therefore the “parallel-plate” capacitive coupling between the movable sense mass 5 and the fixed sensing electrodes 7 is therefore provided, in practice, between the first faces 55a and the respective second faces 75a, i.e., within the aforementioned first coupling portion.

FIG. 3 specifically shows one of the fixed sensing electrodes 7 facing the first arm 51 (e.g., the second portion 512) of the movable sense mass 5. The movable sensing electrode is shown in a rest condition with respect to displacement along the Y-axis. In detail, the sense surface 55 has a step-like profile and is defined by a respective first face 55a, a recessed face 55b, and a connection face 55c that joins the first face 55a and the recessed face 55b. The first face 55a and the recessed face 55b are both flat surfaces, with the recessed face 55b which also extends, for example, parallel to the drive direction X; the connection face 55c is also, for example, flat and extends for example parallel to the sense direction Y. The first face 55a is more proximal to the second face 75a of the sense surface 75 of the fixed sensing electrode 7 than the recessed face 55b. In particular, in the rest condition represented in FIG. 3, the separation distance along the Y-axis between the first face 55a and the second face 75a corresponds to the sense gap g (in the first coupling portion). The separation distance between the recessed face 55b and the second face 75a is greater than the sense gap g, defining the second coupling portion; for example, the separation distance between the recessed face 55b and the second face 75a is equal, at rest, to three times the sense gap g. Furthermore, in the embodiment of FIGS. 2 and 3, the second face 75a coincides with the entire sense surface 75 of the respective fixed sensing electrode 7 and is a substantially flat face. Finally, with reference in particular to FIG. 2, the sense openings 54 follow the same profile as the first arm 51 of the movable sense mass 5.

Movements of the movable sense mass 5, and therefore of the first arm 51, along the drive direction X, due to being driven by the respective drive mass 4, cause a variation in the capacitive coupling between the first face 55a and the second face 75a. In detail, a projection L of the first face 55a onto the second face 75a along the sense direction Y is variable, in use, with an oscillation of the movable sense mass 5 along the drive direction X. As represented in FIG. 3, the projection L has, at rest, a length (along the X-axis) at rest coincident with a rest value L_{OV} of superimposition, for example equal to 20 μm. When the MEMS structure 3 is actuated along the drive direction X, the projection L oscillates between a minimum value L_{MIN} and a maximum value L_{MAX} of superimposition between the first face 55a and the second face 75a; for example, the entire stroke |L_{MAX}-L_{MIN}| may be less than 30 μm. In a non-limiting embodiment, only when the projection L reaches the maximum value L_{MAX} does the second face 75a superimpose almost completely on the first face 55a (and therefore provides maximum capacitive coupling-see below); at rest for example, part of the second face 75a is arranged facing the recessed face 55b (in the second coupling portion).

In practice, the oscillation imparted by the drive signal S_{D} is, for example, a sinusoidal oscillation and generates a displacement of the masses that are movable along the drive direction X equal to x(t)=X_{D} sin(ω_{D}t), with op where wp is the angular frequency of such displacement. The projection L therefore oscillates sinusoidally between LMIN=LOV−XD and LMAX=LOV+XD. Accordingly, the capacitance between the first face 55a of the movable sense mass 5 and the second face 75a of the fixed sensing electrode 7 is given by:

$$C ( t ) = ε \frac{{L}_{OV} + x ( t )}{g + {y}_{S} ( t )} H \qquad ( 1 )$$

where:
ε is the dielectric constant of the gas mixture internal to the gyroscope 1;
L_{OV} is the rest value of the projection L;
x(t) is indicative of the drive oscillations of the movable sense mass 5;
g is the sense gap;
yₛ(t) is indicative of the sense oscillations of the movable sense mass 5; and
H is the contribution of the area of the first coupling portion, i.e. the facing area between the fixed sensing electrode 7 and the movable sense mass 5, along the Z-axis; His for example equal to a thickness along the Z-axis of the movable sense mass 5.

In the above example, for simplicity, it is assumed that the contribution of the second coupling portion, i.e., the capacitive coupling between the fixed sensing electrode 7 and the recessed face 55b of the movable sense mass 5, is zero or, in any case, negligible.

Formula (1) highlights how the capacitance C (t) between each fixed sensing electrode 7 and the movable sensing electrode of the movable sense mass 5 depends on the position of the movable sense mass 5 along the drive direction X. Since the movable sense mass 5 oscillates along the drive direction X with angular frequency OD, the capacitance C (t) also varies sinusoidally with the same angular frequency and is in phase with the displacement of the movable sense mass 5.

The Applicant has verified that, for a MEMS structure 3 of the mode-matched type, i.e., a MEMS structure in which the drive oscillation frequency is substantially coincident with the sense oscillation frequency, a sense displacement y caused by a rotation about the Z-axis with angular velocity 22 is substantially equal to:

$$y = 2 Ω {X}_{D} \frac{Q}{{ω}_{D}} sin ( {ω}_{D} t ) \qquad ( 2 )$$

where:
X_{D} is the maximum value of displacement along the drive direction X; and
Q is the quality factor of the oscillation system along the sense direction Y.

A capacitive variation AC due to the sense displacement y is, following suitable filtering of the harmonics of the drive oscillation frequency, substantially equal to:

$$Δ C = \frac{ε H}{{g}^{2}} \frac{Q}{{ω}_{D}} Ω {X}_{D}^{2} \qquad ( 3 )$$

As may be understood from the foregoing, in the gyroscope of the present invention, thanks to the time variability of the capacitive coupling along the drive direction X, the sense signal that may be extracted from the sensing electrodes is already in baseband and therefore does not require demodulation. In fact, owing to the variable facing between the sensing electrodes which is variable with the oscillations of the MEMS structure along the drive direction X, an intrinsic electromechanical demodulation of the sense signal is obtained. Specifically, the electromechanical demodulation implemented internally within the MEMS structure occurs automatically and intrinsically in phase with the oscillation of the MEMS structure (and therefore also of the movable sense mass) along the drive direction X. This ultimately allows elimination of phase errors in demodulation of the sense signal that may depend on a purely electronic demodulation and/or from phase drifts due to thermomechanical stresses acting on the gyroscope. Furthermore, the electromechanical demodulation of the gyroscope according to the present invention is intrinsically stable, enabling a nearly linear response of the gyroscope as the angular velocity varies and a substantial reduction in reading contributions due to quadrature phenomena.

In light of the foregoing, it is understood that the same advantages may also be obtained with a MEMS structure comprising a single fixed sensing electrode facing a single sense surface of the movable sensing electrode of the movable sense mass, provided that the previously described variable facing is implemented. Accordingly, the double-differential embodiment of FIGS. 2 and 3, although particularly advantageous, is not to be understood as limiting.

In the following description, with reference to FIGS. 4-6, further possible embodiments of the variable capacitive coupling between fixed sensing electrodes and the movable sensing electrode of the movable sense mass are presented by way of example. Unless otherwise specified, elements of FIGS. 4-6 that correspond to elements of FIGS. 2 and 3 are indicated by the same reference numerals.

According to one embodiment illustrated in FIG. 4, a microelectromechanical gyroscope comprises a movable sense mass 105 and four fixed sensing electrodes 107. The movable sense mass 105 is cross-shaped and comprises a second arm 152, analogous to the second arm 52 of FIG. 2, and a first arm 151 whose sense surfaces 155 have a flat profile (i.e., the first arm 151 is the movable sensing electrode). The movable sense mass 105 of FIG. 4 therefore comprises four first faces 155a coincident with the respective sense surfaces 155. Each fixed sensing electrode 107 is arranged adjacent to both the first arm 151 and the second arm 152 and has a respective sense surface 175. Each sense surface 175 of the fixed sensing electrodes 107 has a step-like profile and comprises a respective second face 175a and a recessed face 175b connected to each other. The second faces 175a and the recessed faces 175b are both flat and extend parallel to the drive direction X; accordingly, the fixed sensing electrodes 107 of FIG. 4 therefore have a substantially “L” shape in plan. For each sense surface 175 of the fixed sensing electrodes 107, the second face 175a is closer to the first face 155a of the corresponding sense surface 155 of the movable sense mass 105 than the recessed face 175b. Also in FIG. 4, the capacitive coupling between the second faces 175a and the respective first faces 155a varies as the corresponding projections L of the first faces 155a onto the second faces 175a vary with the position of the movable sense mass 105 along the drive direction X (i.e. with the oscillations of the movable sensing electrode along the drive direction X). Furthermore, the fixed sensing electrodes 107 shown in FIG. 4 are arranged and oriented with respect to the Z-axis so as to implement a differential measurement of the displacements caused by the Coriolis force.

FIG. 5 shows an arrangement that is entirely analogous to that of FIGS. 2 and 3, and therefore the same reference numerals are used. The movable sense mass 5 of FIG. 5 differs from the movable sense mass 5 of FIG. 2 in that the absence of a frame portion 53 and by the absence of the sense openings. The fixed sensing electrodes 7 are therefore each arranged adjacent to both the first arm 51 and the second arm 52, similarly to the configuration shown in FIG. 4. Furthermore, in the arrangements of both FIG. 4 and FIG. 5, the sense elastic elements (not shown) are connected directly to the second arm of the movable sense mass.

Finally, FIG. 6 shows an arrangement comprising a movable sense mass 205 and two fixed sensing electrodes that are analogous to the fixed sensing electrodes 7 of FIG. 2 and are therefore indicated with the same reference numerals. In detail, the movable sense mass 205 comprises a single body (the movable sensing electrode in FIG. 6 therefore coincides with the entire body)—for example rectangular in plan—wherein two sense openings 54 analogous to those of FIG. 2 are obtained. Each sense opening 54 accommodates a respective fixed sensing electrode 7. The sense openings 54 are arranged, for example, symmetrically with respect to a center of the body of the movable sense mass 205. The movable sense mass 205 of FIG. 6 therefore has two sense surfaces 55, each sense surface 55 delimiting a respective sense opening 54 and being step-shaped so as to comprise a respective first face 55a at a separation distance from the respective fixed sensing electrode 7 by a distance equal, for example at rest, to the sense gap g. The same advantages previously described above may also be obtained using the sensing electrode arrangement of the sensing electrodes of FIG. 6. Furthermore, the arrangement of the sensing electrodes of FIG. 6 also allows for a differential measurement.

FIG. 7 shows an example embodiment of the signal conditioning module 13 of FIG. 1 for reading the sense signal Vs. For convenience, hereinafter reference is made to the reference numerals of FIGS. 2 and 3; however, it is understood that the sensing electrodes of FIGS. 4-6 may be used equivalently.

In detail, the signal conditioning module 13 comprises a variable voltage generator 131, a first filter 132, a multiplier 133, and a second filter 134. The variable voltage generator 131 allows a bias voltage applied to the movable sense mass 5, i.e., to the movable sensing electrode, to be modulated with a modulation signal VMOD, for example a sinusoidal signal, at a modulation frequency fMOD. In this manner, since the capacitive variation AC of the capacitive coupling is a pseudo-DC signal, as it depends on the quasi-static nature of the angular velocity (see, for example formula (3) above), the sense current i_{S} is also a modulated current, according to i_{S}=ΔC·dV_{MOD}/dt.

The charge-to-voltage converter 12 then generates the sense signal VS based on the sense current iS. Thanks to modulation of the bias voltage of the movable sense mass 5, electronic offset terms remain confined to a DC component of the sense signal VS, while the useful signal (i.e. indicative of the sense displacement) is in a component at the modulation frequency fMOD. In this manner, the reading stability of the sense signal VS may be significantly improved.

Subsequently, the sense signal VS is filtered by the first filter 132, which comprises a low-pass filter having a cut-off frequency equal to twice the oscillation frequency of the movable sense mass 5 along the drive direction X (f_{D}=ω_{D}/2π. In this manner, harmonics of the drive oscillation frequency are eliminated. The filtered sense signal VS is then demodulated with respect to the modulation frequency fMOD in a coherent manner using the multiplier 133 and the second filter 134. The multiplier 133 has a first input that receives the output of the first filter 132 and a second input which receives the modulation signal VMOD. The second filter 134 comprises a low-pass filter having a cut-off frequency equal to twice the modulation frequency fMOD, so as to eliminate the corresponding harmonics and provide the filtered sense signal VSF.

According to the advantages described above, the electrical demodulation implemented by the scheme of the signal conditioning module 13 is not critical with respect to quadrature contributions in the reading of the sense signal VS. In fact, as described, the electromechanical demodulation enabled by the arrangement of the sensing electrodes according to the present invention allows for a sense current is that is substantially indicative only of the contribution of the Coriolis force and is intrinsically in phase with the oscillation of the movable sense mass along the drive direction X. As may be noted from FIGS. 1 and 7, an electrical demodulation stage that uses the drive signal SD as a demodulation reference is absent in the gyroscope of the present invention, since such demodulation is not necessary.

Finally, it is clear that modifications and variations may be made to the embodiments described and illustrated herein without thereby departing from the scope of the present invention, as defined in the attached claims.

For example, the MEMS structure may comprise only one of the sectors described and illustrated above, while still achieving the same advantages.

In an alternative embodiment to that shown in FIG. 2, the sense surfaces, i.e., the respective first face and recessed face, of the movable sense mass are formed on respective parts of the frame portion arranged facing the already described respective fixed sensing electrodes described above, while the first arm of the movable sense mass has a flat profile. In an alternative of this version of the movable sense mass, the first and second arms are completely omitted.

The MEMS structure shown may be adapted in its internal components in order to also sense additional types of rotation (e.g., roll and pitch), thereby implementing a multiaxial gyroscope.

1. A microelectromechanical gyroscope, comprising:
a support body;
a drive mass constrained to the support body to be able to oscillate along a drive direction;
a sense mass constrained to the drive mass to translate rigidly with the drive mass in the drive direction and able to oscillate with respect to the drive mass along a sense direction perpendicular to the drive direction;
a movable sensing electrode carried by the sense mass; and
at least one fixed sensing electrode anchored to the support body and capacitively coupled to the movable sensing electrode,
wherein the movable sensing electrode and the at least one fixed sensing electrode are shaped so that a capacitance between the movable sensing electrode and the at least one fixed sensing electrode is a function of a position of the sense mass along the drive direction and of a position of the sense mass along the sense direction.

2. The gyroscope according to claim 1, wherein the capacitance between the movable sensing electrode and the at least one fixed sensing electrode varies, in use, substantially with the same frequency and substantially in-phase with an oscillation of the sense mass along the drive direction.

3. The gyroscope according to claim 1, wherein the movable sensing electrode has at least one sense surface comprising a first face, and wherein the at least one fixed sensing electrode has a respective sense surface arranged facing the respective at least one sense surface of the movable sensing electrode and comprising a second face,
wherein the first face and the second face extend along the drive direction and are capacitively coupled to each other, and
wherein a projection of the first face on the second face along the sense direction depends on the position of the sense mass along the drive direction.

4. The gyroscope according to claim 3,
wherein one of the at least one sense surface of the movable sensing electrode and the sense surface of the respective at least one fixed sensing electrode has a step-like profile, and
wherein the other of the at least one sense surface of the movable sensing electrode and the sense surface of the respective at least one fixed sensing electrode has a flat profile.

5. The gyroscope according to claim 3, wherein the at least one sense surface of the movable sensing electrode has a step-like profile and is delimited by the respective first face and a recessed face, the first face being more proximal to the second face of the sense surface of the respective at least one fixed sensing electrode with respect to the recessed face, and
wherein the sense surface of the respective at least one fixed sensing electrode has a flat profile.

6. The gyroscope according to claim 3, wherein the sense surface of the at least one fixed sensing electrode has a step-like profile and is delimited by the respective second face and a recessed face, the second face being more proximal to the first face of the respective at least one sense surface of the movable sensing electrode with respect to the recessed face, and
wherein the respective at least one sense surface of the movable sensing electrode has a flat profile.

7. The gyroscope according to claim 3, wherein the movable sensing electrode comprises a first arm, extending along the drive direction and comprising the at least one sense surface, the sense mass further comprising a second arm, extending along the sense direction, the first arm and the second arm being arranged as a cross with respect to one another.

8. The gyroscope according to claim 7,
wherein the first arm comprises a first portion and a second portion, the second arm being interposed between the first portion and the second portion, and wherein the first portion and the second portion each comprise a pair of sense surfaces of the movable sensing electrode opposite to each other along the sense direction,
the gyroscope further comprising a plurality of fixed sensing electrodes, the sense surfaces of the first portion and of the second portion each being arranged facing a respective sense surface of a corresponding fixed sensing electrode.

9. The gyroscope according to claim 8, wherein the sense mass further comprises a frame portion, coupled to respective ends of the first arm and the second arm and delimiting respective sense openings therewith, and wherein each sense opening accommodates a respective fixed sensing electrode.

10. The gyroscope according to claim 1, wherein the drive mass has a frame shape and delimits a drive opening, the sense mass and the at least one fixed sensing electrode being accommodated in the drive opening.

11. A method of operating a microelectromechanical gyroscope, the gyroscope comprising: a support body; a drive mass, constrained to the support body to be able to oscillate along a drive direction; a sense mass, constrained to the drive mass to translate rigidly with the drive mass in the drive direction and to be able to oscillate with respect to the drive mass along a sense direction perpendicular to the drive direction; a movable sensing electrode, carried by the sense mass; and at least one fixed sensing electrode, anchored to the support body and capacitively coupled to the movable sensing electrode, wherein the movable sensing electrode and the at least one fixed sensing electrode are shaped so that a capacitance between the movable sensing electrode and the at least one fixed sensing electrode is a function of a position of the sense mass along the drive direction and of a position of the sense mass along the sense direction, the method comprising:
causing the drive mass to oscillate along the drive direction; and
extracting a sense signal, indicative of an oscillation of the sense mass along the sense direction;
wherein the sense signal depends on a variation in the capacitance between the movable sensing electrode and the at least one fixed sensing electrode.

12. The method according to claim 11, wherein the variation in capacitance between the movable sensing electrode and the at least one fixed sensing electrode has substantially the same frequency and is substantially in-phase with the oscillation of the sense mass along the drive direction.

13. The method according to claim 11, wherein extracting the sense signal comprises:
modulating a bias voltage of the movable sensing electrode with a modulation signal;
generating the sense signal using a charge-to-voltage converter;
filtering the sense signal using a low-pass filter with a cut-off frequency equal to twice the oscillation frequency of the sense mass along the drive direction; and
coherently demodulating the sense signal, using the modulation signal.

14. A method of operating a microelectromechanical gyroscope, comprising:
causing a drive mass of the gyroscope to oscillate along a drive direction;
causing a sense mass of the gyroscope to translate with the drive mass along the drive direction while oscillating, relative to the drive mass, along a sense direction perpendicular to the drive direction; and
extracting a sense signal indicative of the oscillation of the sense mass along the sense direction, wherein the sense signal depends on a capacitance between a movable sensing electrode carried by the sense mass and at least one fixed sensing electrode anchored to a support body of the gyroscope, the capacitance varying as a function of a position of the sense mass along the drive direction and as a function of a position of the sense mass along the sense direction.

15. The method according to claim 14, wherein the variation in capacitance between the movable sensing electrode and the at least one fixed sensing electrode has substantially the same frequency and is substantially in-phase with the oscillation of the sense mass along the drive direction.

16. The method according to claim 14, wherein extracting the sense signal comprises:
modulating a bias voltage of the movable sensing electrode with a modulation signal;
generating the sense signal using a charge-to-voltage converter;
filtering the sense signal using a low-pass filter with a cut-off frequency equal to twice the oscillation frequency of the sense mass along the drive direction; and
coherently demodulating the sense signal, using the modulation signal.
